(19) United States
(12) Patent Application Publication
(10) Pub. No.: US 2022/0144245 A1
(43) Pub. Date: May 12, 2022

(54) CONTROL DEVICE, CONTROL METHOD, AND ELECTRICAL VEHICLE

(71) Applicant: HONDA MOTOR CO., LTD., Tokyo (JP)

(72) Inventors: Nobuyuki ARUGA, Tokyo (JP); Akio FUTATSUDERA, Tokyo (JP); Masashi ETO, Tokyo (JP)

(73) Assignee: HONDA MOTOR CO., LTD., Tokyo (JP)

(21) Appl. No.: 17/509,517

(22) Filed: Oct. 25, 2021

(30) Foreign Application Priority Data
Nov. 6, 2020 (JP) 2020-185884

(51) Int. Cl. B60W 20/12; B60W 10/08; B60W 10/06; B60W 10/26; B60W 40/105

(52) U.S. Cl. CPC B60W 20/12; B60W 10/08; B60W 10/06; B60W 2556/45; B60W 40/105; B60W 2510/244; B60W 10/26

(57) ABSTRACT

A management ECU of an electrical vehicle creates a travelling plan in which any one of travelling modes is assigned to each of traveling sections of a scheduled traveling route from a current position of the electrical vehicle to a destination and control the travelling modes based on the travelling plan. When a total estimated value of an amount of electric power required for traveling in each of the traveling sections in a first traveling mode exceeds a current SOC, the management ECU extracts a section in which an output estimated value exceeds a second predetermined value as a planning target section, and creates the traveling plan in which a second traveling mode in which a usage amount of electric power of a storage battery is smaller than that in the first traveling mode is assigned preferentially to a section farther from the electrical vehicle among the planning target sections.

### CROSS-REFERENCE TO RELATED APPLICATIONS

The present application claims the benefit of priority of Japanese Patent Application No. 2020-185884, filed on Nov. 6, 2020, the content of which is incorporated herein by reference.

### TECHNICAL FIELD

The present invention relates to a control device and a control method that control travelling by creating a travelling plan, and an electrical vehicle.

### BACKGROUND ART

In the related art, a hybrid vehicle has been known, which includes an internal combustion engine, an electric motor, and a storage battery that can be charged with electric power, which is generated by the electric motor (generator) using power of the internal combustion engine, or external electric power. Such a hybrid vehicle can travel in various travelling modes. Examples of the traveling mode include an EV mode in which a vehicle travels only by an output of an electric motor that is driven by electric power of a storage battery after an internal combustion engine is stopped, and a series mode in which a vehicle travels by an output of an electric motor that is driven by the supply of electric power generated by a generator using power of an internal combustion engine.

These traveling modes are selected and switched in accordance with various situations. For example, in the related art, JP-A-2015-685 has proposed to determine a travelling mode in consideration of the entire travelling route to a destination on the basis of vehicle speed information or the like of each section.

In addition, JP-A-2015-157530 has proposed to plan an EV mode in which priority is given to EV traveling, in which an engine is stopped and a motor device is used as a drive source in order from a section having a low traveling load based on a remaining battery level, and plan an HV mode in which priority is given to HV traveling in which an engine is driven to regenerate a motor device in a link other than the EV plan section.

### SUMMARY OF INVENTION

In a vehicle including a storage battery and an internal combustion engine, an energy efficiency of traveling to a destination tends to increase by assigning traveling using the storage battery to a low-load traveling section and assigning traveling using the internal combustion engine to a high-load traveling section.

However, in the configuration of Patent Literature 1, the traveling mode is switched based on the vehicle speed information or the like, and the improvement in the energy efficiency caused by switching the traveling mode in accordance with the load of the traveling section cannot be achieved.

In the configuration of Patent Literature 2, since the EV mode is assigned in ascending order of the traveling load, hunting that the traveling modes are frequently switched is likely to occur.

The present embodiment provides a control device, a control method, and an electrical vehicle, by which hunting of control can be prevented and an energy efficiency of traveling can be improved.

The present environment provides a control device for an electrical vehicle that includes an internal combustion engine, a storage battery, and an electric motor driven by the supply of electric power from the storage battery and travels in a plurality of traveling modes including a first traveling mode and a second traveling mode in which a usage amount of electric power of the storage battery is smaller than that in the first traveling mode, the control device comprising:

a travelling planning unit configured to create a travelling plan in which any one of the plurality of travelling modes is assigned to each of traveling sections of a scheduled traveling route from a current position of the electrical vehicle to a destination, and

a control unit configured to control the travelling modes of the electrical vehicle based on the travelling plan created by the travelling planning unit;

wherein, when a total estimated value of an amount of electric power required for traveling in each of the traveling sections in the first traveling mode exceeds a first predetermined value based on a charging state of the storage battery at the time of creating the traveling plan, the travelling planning unit extracts a section in which an estimated value of an output required for traveling exceeds a second predetermined value from the traveling sections as a planning target section, and creates the traveling plan in which the second traveling mode is assigned preferentially to a section farther from the electrical vehicle among the planning target sections.

The present environment also provides a control method of an electrical vehicle that includes an internal combustion engine, a storage battery, and an electric motor driven by the supply of electric power from the storage battery, and travels in a plurality of traveling modes including a first traveling mode and a second traveling mode in which a usage amount of electric power of the storage battery is smaller than that in the first traveling mode, the control method comprising:

a travelling planning step of creating a travelling plan in which any one of the plurality of travelling modes is assigned to each of traveling sections of a scheduled traveling route from a current position of the electrical vehicle to a destination; and

a control step of controlling the travelling modes of the electrical vehicle based on the travelling plan created by the travelling planning step,

wherein when a total estimated value of an amount of electric power required for traveling in each of the traveling sections in the first traveling mode exceeds a first predetermined value based on a charging state of the storage battery at the time of creating the traveling plan, a section in which an estimated value of an output required for traveling exceeds a second predetermined value is extracted from the traveling sections as a planning target section, and the traveling plan in which the second traveling mode is assigned preferentially to a section farther from the electrical vehicle among the planning target sections is assigned in the travelling planning step.

The present embodiment also provides an electrical vehicle, which includes an internal combustion engine, a storage battery, and an electric motor driven by the supply of electric power from the storage battery, and travels in a plurality of traveling modes including a first traveling mode and a second traveling mode in which a usage amount of electric power of the storage battery is smaller than that in the first traveling mode, the electrical vehicle comprising:

a travelling planning unit configured to create a travelling plan in which any one of the plurality of travelling modes is assigned to each of traveling sections of a scheduled traveling route from a current position of the electrical vehicle to a destination; and

a control unit configured to control the travelling modes of the electrical vehicle based on the travelling plan created by the travelling planning unit;

wherein, when a total estimated value of an amount of electric power required for traveling in each of the traveling sections in the first traveling mode exceeds a first predetermined value based on a charging state of the storage battery at the time of creating the traveling plan, the travelling planning unit extracts a section in which an estimated value of an output required for traveling exceeds a second predetermined value from the traveling sections as a planning target section, and creates the traveling plan in which the second traveling mode is assigned preferentially to a section farther from the electrical vehicle among the planning target sections.

According to the present embodiment, hunting of control can be prevented and an energy efficiency of traveling can be improved.

### BRIEF DESCRIPTION OF DRAWINGS

FIG. 1 is a block diagram showing an internal configuration of a series/parallel type plug-in hybrid electrical vehicle.

FIG. 2 is a diagram schematically showing a main part of a drive system in the electrical vehicle shown in FIG. 1.

FIG. 3A is a diagram showing a driving state of the electrical vehicle shown in FIG. 1 in an EV mode.

FIG. 3B is a diagram showing a driving state of the electrical vehicle shown in FIG. 1 in a first series mode.

FIG. 3C is a diagram showing a driving state of the electrical vehicle shown in FIG. 1 in a second series mode.

FIG. 3D is a diagram showing a driving state of the electrical vehicle shown in FIG. 1 in an engine direct connection mode.

FIG. 4 is a flowchart showing an example of processing performed by a management ECU shown in FIG. 1.

FIG. 5 is a diagram showing a first specific example of creation of a travelling plan performed by the management ECU shown in FIG. 1.

FIG. 6 is a diagram showing a second specific example of creation of a travelling plan performed by the management ECU shown in FIG. 1.

FIG. 7 is a diagram showing a third specific example of creation of a travelling plan performed by the management ECU shown in FIG. 1.

FIG. 8 is a diagram showing a fourth specific example of creation of a travelling plan performed by the management ECU shown in FIG. 1.

FIG. 9 is a diagram showing a fifth specific example of creation of a travelling plan performed by the management ECU shown in FIG. 1.

FIG. 10 is a diagram showing a sixth specific example of creation of a travelling plan performed by the management ECU shown in FIG. 1.

### DESCRIPTION OF EMBODIMENTS

Hereinafter, an embodiment of the present invention will be described with reference to the drawings.

A hybrid electrical vehicle includes an electric motor and an internal combustion engine and travels by a driving force of the electric motor and/or the internal combustion engine in accordance with a traveling state of the vehicle. There are roughly two types of hybrid electrical vehicles, that is, a series type hybrid electrical vehicle and a parallel type hybrid electrical vehicle. A series type hybrid electrical vehicle travels by power of an electric motor. The internal combustion engine is used only for power generation, and electric power generated by a generator with the power of the internal combustion engine is transmitted to a storage battery or supplied to an electric motor.

Example of the travelling mode of the series type hybrid electrical vehicle first include a travelling mode in which the hybrid electrical vehicle travels by a driving force of an electric motor driven by the supply of electric power from a storage battery. In this case, the internal combustion engine is not driven. Examples of the travelling mode of the series type hybrid electrical vehicle further include a traveling mode in which the hybrid electrical vehicle travels by a driving force of an electric motor driven by the supply of electric power from both the storage battery and the generator, or the supply of electric power from only the generator. In this case, the internal combustion engine is driven for power generation in the generator.

A parallel type hybrid electrical vehicle travels by a driving force of either one or both of an electric motor and an internal combustion engine. Examples of a traveling mode of the parallel type hybrid electrical vehicle particularly include a mode in which the hybrid electrical vehicle travels by a driving force of only the internal combustion engine.

A series/parallel type hybrid electrical vehicle in which a series type and a parallel type are combined is also known. In the series/parallel type, a transmission system of a driving force is switched to a configuration of either one of the series type and the parallel type by releasing or engaging (disconnecting or connecting) a clutch in accordance with a traveling state of the vehicle. In particular, a configuration of the series type is achieved by releasing the clutch during acceleration traveling at a low and medium speed, and a configuration of the parallel type is achieved by engaging the clutch during steady traveling (cruise traveling) at a medium and high speed.

A plug-in hybrid electrical vehicle obtained by adding an external charging function to a hybrid electrical vehicle is also known. The plug-in hybrid electrical vehicle is equipped with a battery having a capacity larger than that of a normal hybrid electrical vehicle, and can be charged with electric power supplied directly from a household power supply using a plug. Therefore, the plug-in hybrid electrical vehicle can travel a longer distance with electricity alone.

<Internal Configuration of Series/Parallel Type Plug-In Hybrid Electrical Vehicle>

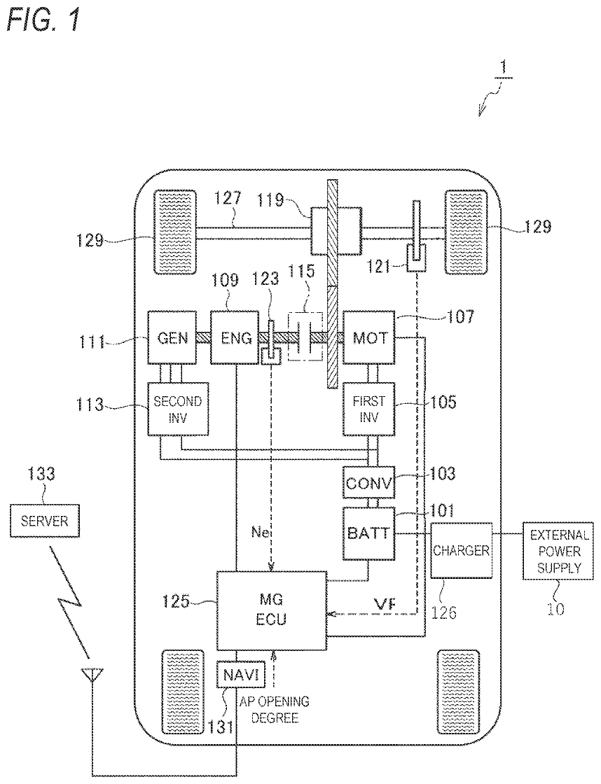

As shown in FIG. 1, a series/parallel type plug-in hybrid electrical vehicle (hereinafter, simply referred to as “electrical vehicle”) 1 includes a storage battery (BATT) 101, a converter (CONV) 103, a first inverter (first INV) 105, an electric motor (MOT) 107, an internal combustion engine (ENG) 109, a generator (GEN) 111, a second inverter (second INV) 113, an engine direct connection clutch (hereinafter, simply referred to as “clutch”) 115, a gearbox (hereinafter, simply referred to as “gear”) 119, a vehicle speed sensor 121, a rotation speed sensor 123, a management ECU (MG ECU) 125, a charger 126, and a navigation system (NAVI) 131 that acquires information from a server 133. In FIG. 1, an arrow of a dotted line indicates value data, and a solid line indicates a control signal including an instruction content. The control device of the present invention can be applied to, for example, the management ECU 125.

The storage battery 101 includes a plurality of power storage cells connected in series, and supplies a high voltage of, for example, 100 to 200[V]. The power storage cell is, for example, a lithium-ion battery or a nickel-metal hydride battery. The converter 103 steps up or steps down a DC output voltage of the storage battery 101 in the DC form. The first inverter 105 converts the DC voltage from the converter 103 into an AC voltage and supplies a three-phase current to the electric motor 107. In addition, the first inverter 105 converts an AC voltage received during a regenerative operation of the electric motor 107 into a DC voltage and charges the storage battery 101.

The charger 126 can be connected to an external power supply 10 via a plug, and can charge the storage battery 101 with electric power of the external power supply 10. For example, the charger 126 includes an inverter that converts an AC voltage of the external power supply 10 into a DC voltage. The external power supply 10 is, for example, a household power supply.

The electric motor 107 generates power for an electrical vehicle 1 to travel. A torque generated by the electric motor 107 is transmitted to a drive shaft 127 via a gear 119. A rotor of the electric motor 107 is directly connected to the gear 119. The electric motor 107 operates as a generator at the time of regenerative braking, and the electric power generated by the electric motor 107 is transmitted to the storage battery 101.

The internal combustion engine 109 is used only for driving the generator 111 when a clutch 115 is released and the electrical vehicle 1 travels in a series manner. However, when the clutch 115 is engaged, an output of the internal combustion engine 109 is transmitted to the drive shaft 127 via the clutch 115 and the gear 119 as mechanical energy for the electrical vehicle 1 to travel.

The generator 111 is driven by power of the internal combustion engine 109 to generate electric power. The electric power generated by the generator 1 is transmitted to the storage battery 101 or supplied to the electric motor 107 via the second inverter 113 and the first inverter 105. The second inverter 113 converts an AC voltage generated by the generator 111 into a DC voltage. The electric power converted by the second inverter 113 is transmitted to the storage battery 101, or supplied to the electric motor 107 via the first inverter 105.

The clutch 115 disconnects or connects a transmission path of a driving force from the internal combustion engine 109 to driving wheels 129 based on an instruction from the management ECU 125.

The gear 119 is, for example, a one-stage fixed gear corresponding to the fifth gear. Therefore, the gear 119 converts a driving force from the electric motor 107 into a rotation speed and a torque at a specific transmission gear ratio, and transmits the rotation speed and the torque to the drive shaft 127. The vehicle speed sensor 121 detects a traveling speed (vehicle speed VP) of the electrical vehicle 1. A signal indicating the vehicle speed VP detected by the vehicle speed sensor 121 is sent to the management ECU 125. The rotation speed sensor 123 detects a rotation speed Ne of the internal combustion engine 109. A signal indicating the rotation speed Ne detected by the rotation speed sensor 123 is sent to the management ECU 125.

The management ECU 125 is an electronic control unit (ECU) that performs calculation of a rotation speed of the electric motor 107 based on the vehicle speed VP, connection and disconnection of the clutch 115, detection of the state of charge (SOC) of the storage battery 101, detection of the accelerator pedal opening degree (AP opening degree), switching of the traveling mode, control of the electric motor 107, the internal combustion engine 109, and the generator 1l1, and the like. The management ECU 125 is an example of a travelling planning unit and a control unit in the present invention.

The navigation system 131 has a communication function and acquires information from the server 133. In the server 133, traveling section information of a road and vehicle speed fluctuation information of other vehicles corresponding to each piece of traveling section information is accumulated. The navigation system 131 acquires required information from the server 133 in accordance with a destination input by a user via an input unit (not shown), sets a scheduled traveling route from a current position to a destination, and sends the scheduled traveling route to the management ECU 125.

<Driving State According to Each Travelling Mode of Electrical Vehicle 1 Shown in FIG. 1>

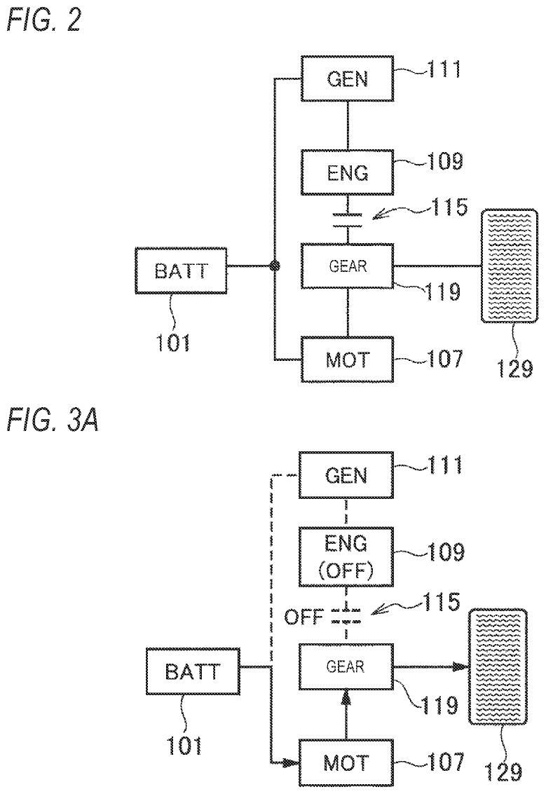

FIG. 2 schematically shows a main part of a drive system in the electrical vehicle 1 shown in FIG. 1.

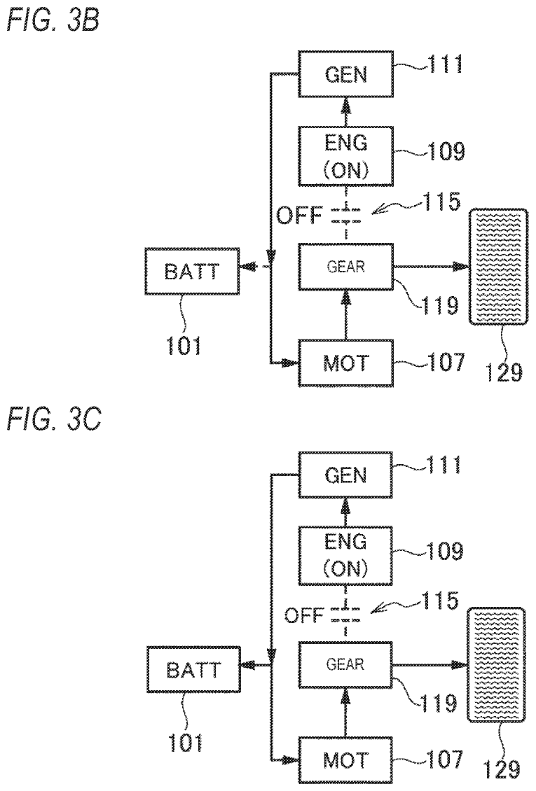

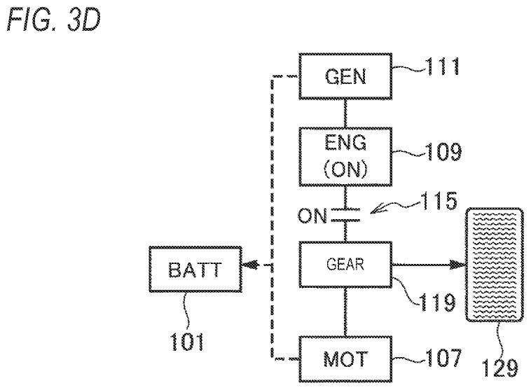

First, as shown in FIG. 3A, the electrical vehicle 1 can travel by a driving force of the electric motor 107 that is driven by the supply of electric power from the storage battery 101, with the clutch 115 released and the internal combustion engine 109 stopped (EV mode).

The electrical vehicle 1 can also travel by a driving force of the electric motor 107 that is driven by the supply of electric power generated by the generator 111 with power of the internal combustion engine 10) while releasing the clutch 115 (series mode). As shown in FIG. 3B, examples of this traveling mode include a mode in which the power of the internal combustion engine 109 causes the generator 111 to generate only electric power that allows the electric motor 107 to output a required output based on the accelerator pedal opening degree, the vehicle speed, and the like. At this time, charging and discharging in the storage battery 101 are not performed in principle.

Further, as shown in FIG. 3C, there is a mode in which the power of the internal combustion engine 109 causes the generator 111 to generate not only the electric power that allows the electric motor 107 to output a required output based on the accelerator pedal opening degree, the vehicle speed, and the like but also electric power with which the storage battery 101 can be charged. Although not shown, when the required output is large, it is also possible to supply the electric power from the storage battery 101 to the electric motor 107 as assist electric power.

Further, as shown in FIG. 3D, the electrical vehicle 1 can also travel by a driving force of the internal combustion engine 109 by engaging the clutch 115 (engine direct connection mode). Also in the engine direct connection mode, when the required output is large, it is possible to use the driving force of the electric motor 107 driven by the supply of electric power from the storage battery 101, in addition to the driving force of the internal combustion engine 109.

Each of the traveling modes described above can be classified into a first traveling mode and a second traveling mode. The first traveling mode is a traveling mode in which priority is given to the traveling using the electric power of the storage battery 101 as compared with the second traveling mode. The second traveling mode is a traveling mode in which priority is given to the traveling in which the amount of electricity stored in the storage battery 101 is maintained as compared with the first traveling mode. In other words, the first traveling mode is a traveling mode in which the electrical vehicle travels using the electric power of the storage battery 101 in preference to the power of the internal combustion engine 109, and the second traveling mode is a traveling mode in which the electrical vehicle travels using the power of the internal combustion engine 109 in preference to the electric power of the storage battery 101.

The first traveling mode includes the EV mode described above.

The second traveling mode includes the series mode and the engine direct connection mode described above. These second traveling modes can be classified into a non-assist traveling mode in which the amount of electricity stored in the storage battery 101 is maintained within a predetermined range, and an assist traveling mode in which traveling using the power of the internal combustion engine 109 is assisted by driving of the electric motor 107 with the electric power of the storage battery 101.

The non-assist traveling mode includes a mode in the series mode, in which the electric power of the storage battery 101 is not used as assist electric power, and a mode in the engine direct connection mode, in which the driving force of the electric motor 107 driven by the supply of electric power from the storage battery 101 is not used. The non-assist traveling mode is an example of a first mode of the present invention.

The assist traveling mode includes a mode in the series mode, in which the electric power from the storage battery 101 is used as the assist electric power, and a mode in the engine direct connection mode, in which the driving force of the electric motor 107 driven by the supply of electric power from the storage battery 101 is used. The assist traveling mode is an example of a second mode of the present invention.

As described above, the storage battery 101 of the electrical vehicle 1 can be charged with external electric power. Therefore, if a charging environment is provided at the destination, the storage battery 101 can be charged with external electric power via the charger 126. In order to efficiently use the external electric power by increasing the amount of charge at this time, it is necessary to sufficiently lower the SOC of the storage battery 101 at the time point of arriving at the destination. Therefore, the management ECU 125 perform control such that the electrical vehicle 1 is caused to travel from the current position in the EV mode to sufficiently reduce the SOC of the storage battery 101, and then the internal combustion engine 109 is driven to cause the electrical vehicle 1 to travel in the series mode or the engine direct connection mode.

The navigation system 131 sets a scheduled traveling route from the current position to the destination in accordance with the input of the destination from the user. In this case, the navigation system 131 acquires information on roads constituting the scheduled traveling route from the server 133. The information on roads accumulated in the server 133 includes road types such as expressways, toll roads, and general roads, legal speed limits of these roads, and the like. Therefore, the navigation system 131 can predict a point at which high-speed traveling is required in accordance with the setting of the scheduled traveling route.

In the information on road acquired from the server 133 in accordance with the input of the destination from the user, the scheduled traveling route is divided into a plurality of traveling sections. A delimiter of the traveling section is provided at a boundary of the road types or a destination or a transit point received by the navigation system 131, and is provided such that a distance of the traveling section is equal to or less than a predetermined value at the maximum. Information, such as the road type, an average vehicle speed, and a distance, on each traveling section constituting the scheduled traveling route is received by the navigation system 131. These pieces of information can also be acquired by the management ECU 125 via the navigation system 131, for example.

The average vehicle speed in each traveling section is obtained, for example, as an average value of legal speed limits from a start point to an end point of one section. Alternatively, the average vehicle speed in each traveling section may be obtained as an average value of vehicle speeds of other vehicles corresponding to each traveling section.

<Processing by Management ECU 125>

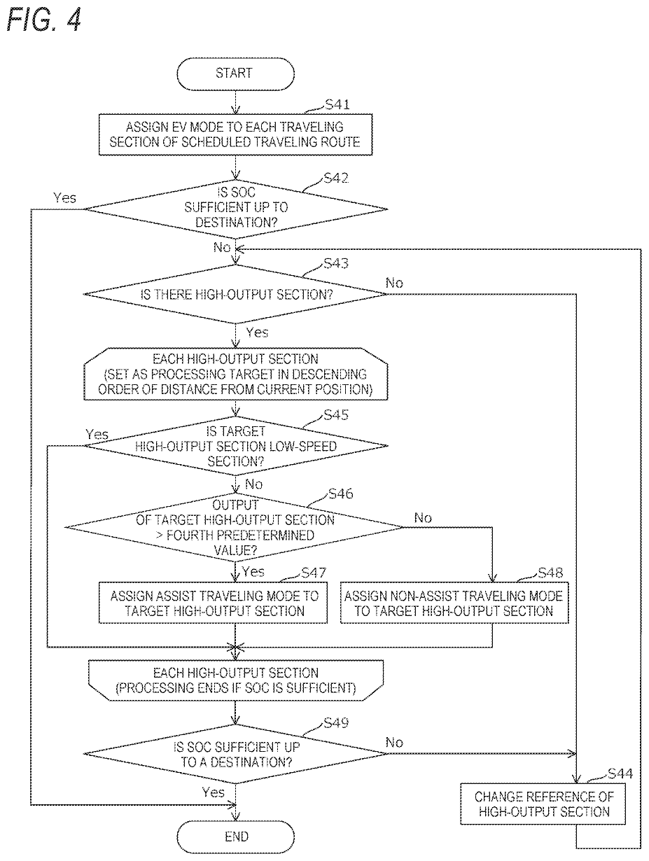

As shown in FIG. 4, first, the management ECU 125 assigns an EV mode (first traveling mode) as an initial value to each traveling section of the scheduled traveling route acquired from the navigation system 131 (step S41). As a result, a provisional travelling plan in which the EV mode is assigned to all the traveling sections is created.

Next, the management ECU 125 determines whether the SOC of the storage battery 101 is sufficient up to a destination (an end point of a scheduled traveling route) input by a user in a current travelling plan (step S42). Specifically, with respect to the current traveling plan, the management ECU 125 calculates an estimated value of an amount of electric power required for traveling in each traveling section of the scheduled traveling route, and determines whether a total value (total estimated value) of the calculated estimated values exceeds a first predetermined value based on the current (at the time of creating the traveling plan) charging state of the storage battery 101.

The estimated value of the amount of electric power required for traveling in the traveling section can be calculated based on, for example, the traveling mode assigned to the traveling section, the average vehicle speed in the traveling section, the distance of the traveling section, and the amount of electric power predicted in relation to a transmission efficiency from the storage battery 101 and consumption of auxiliary machines.

The first predetermined value based on the current charging state of the storage battery 101 is, for example, the amount of electric power at which the current electric power of the storage battery 101 is used up. Alternatively, the first predetermined value based on the current charging state of the storage battery 101 may be an amount of electric power that is smaller by a certain amount than the amount of electric power at which the current electric power of the storage battery 101 is used up, so that a certain amount of margin is generated. In step S42, the management ECU 125 determines that the SOC is sufficient when the total estimated value is equal to or less than the first predetermined value, and determines that the SOC is insufficient when the total estimated value exceeds the first predetermined value.

In step S42, when the SOC is sufficient (step S42: No), the management ECU 125 ends the series of processing. In this case, the travelling plan in which the EV mode is assigned to all the traveling sections is created as a current travelling plan.

In step S42, when the SOC is insufficient (step S42: Yes), the management ECU 125 determines whether there is a high-output section in the scheduled traveling route (step S43). Specifically, the management ECU 125 calculates an estimated value of an output required for traveling with respect to each traveling section of the scheduled traveling route, and determines a section in which the calculated estimated value exceeds a second predetermined value as a high-output section. The output required for traveling is, for example, a load (energy amount) required for traveling per unit distance. The estimated value of the output required for traveling in the traveling section can be calculated based on, for example, information such as road types, an average vehicle speed, and a distance of the traveling section.

In step S43, when there is no high-output section in the scheduled traveling route (step S43: No), the management ECU 125 changes a reference of the high-output section (step S44), and the processing returns to step S43. Specifically, the management ECU 125 changes the second predetermined value described above to a value lower than the current value. As a result, the determination of the high-output section is performed again in a state in which each traveling section is easily determined as the high-output section.

In step S43, when there is a high-output section in the scheduled traveling route (step S43: Yes), the management ECU 125 sets each high-output section of the scheduled traveling route as a target high-output section earlier as the distance from the current position increases, and executes the processing of steps S45 to S48.

First, the management ECU 125 determines whether the target high-output section is a low-speed section (step S45). Specifically, the management ECU 125 determines that the high-output section is a low-speed section when an estimated value of a vehicle speed in the target high-output section is equal to or less than a third predetermined value, and determines that the high-output section is a high-speed section when the estimated value of the vehicle speed in the target high-output section exceeds the third predetermined value. The third predetermined value is a reference for determining whether the traveling section is a low-speed section such as an urban area, and is stored in advance in, for example, a memory of the management ECU 125. The estimated value of the vehicle speed in the high-output section is, for example, an average vehicle speed in the high-output section.

In step S45, when the target high-output section is the low-speed section (step S45: Yes), the management ECU 125 ends the processing of steps S45 to S48 for the high-output section. As a result, the high-output section is not a planning target section to which the second traveling mode (the assist traveling mode or the non-assist traveling mode) is assigned.

In step S45, when the target high-output section is not the low-speed section (step S45: No), the management ECU 125 determines whether the output required for traveling in the target high-output section exceeds a fourth predetermined value (step S46). The high-output section is a reference for determining whether the section is a section for which high output is particularly required. The fourth predetermined value is stored in advance in, for example, the memory of the management ECU 125.

In step S46, when the output required for traveling in the target high-output section exceeds the fourth predetermined value (step S46: Yes), the management ECU 125 assigns the assist traveling mode to the target high-output section (step S47). When the output required for traveling in the target high-output section is equal to or less than the fourth predetermined value (step S46: No), the management ECU 125 assigns the non-assist traveling mode to the target high-output section (step S48).

After step S47 or step S48, similar to step S42, the management ECU 125 determines whether the SOC is sufficient up to the destination in the current travelling plan. When the SOC is insufficient, the management ECU 125 changes the target high-output section to the next high-output section, and executes the processing of steps S45 to S48 again. When the SOC is sufficient, the management ECU 125 ends the processing of steps S45 to S48 for each high-output section, and shifts the processing to step S49. When the management ECU 125 executes the processing of steps S45 to S48 for all the high-output sections even if the SOC is insufficient, the processing is shifted to step S49.

In step S49, the management ECU 125 determines whether the SOC is sufficient up to the destination in the current travelling plan (step S49). For example, when the processing is shifted to step S49 because the SOC is sufficient in the loop processing of steps S45 to S48, it is determined that the SOC is sufficient in step S49. In addition, when the processing is shifted to step S49 due to completion of targeting all the high-output sections in the loop processing of steps S45 to S48, it is determined in step S49 whether the SOC is sufficient by the same processing as in step S42.

In step S49, when the SOC is insufficient (step S49: No), the management ECU 125 shifts the processing to step S44. As a result, it is possible to re-create the travelling plan in a state in which each traveling section is easily determined as the high-output section. When the SOC is sufficient (step S49: Yes), the management ECU 125 ends the series of processing.

The travelling plan can be created by the processing shown in FIG. 4. The management ECU 125 controls, based on the created travelling plan, a travelling mode of the electrical vehicle 1 when the electrical vehicle 1 travels along the scheduled traveling route.

<Processing of Increasing Fourth Predetermined Value>

When the SOC is insufficient in step S49 (step S49: No), the management ECU 125 may perform processing of increasing the fourth predetermined value instead of shifting the processing to step S44 and changing the reference of the high-output section (reducing the second predetermined value), and may perform the loop processing of steps S45 to S48 again. As a result, in steps S46 to S48, the non-assist traveling mode in which the SOC consumption is small is easily assigned to the high-output section.

The processing of increasing the fourth predetermined value may be used in combination with the processing of reducing the second predetermined value. For example, a lower limit for reducing the second predetermined value is set, and when the SOC is insufficient, the processing of reducing the second predetermined value may be performed until the second predetermined value reaches the lower limit, and the processing of increasing the fourth predetermined value may be performed when the second predetermined value reaches the lower limit. The processing of increasing the fourth predetermined value may be performed only when the assist traveling mode is assigned to the travelling plan being created.

<Specific Example of Creation of Traveling Plan by Management ECU 125>

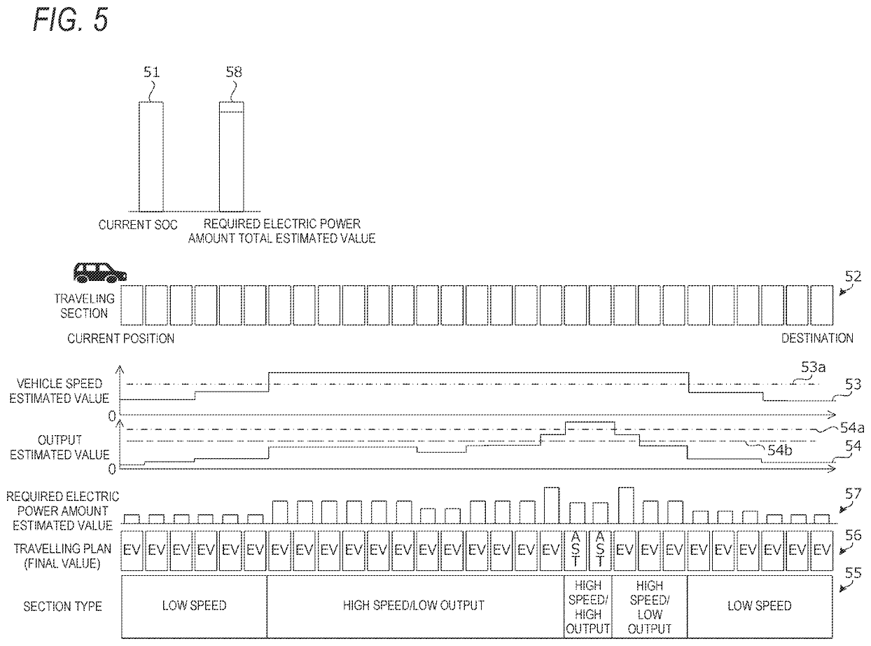

In FIGS. 5 to 10, a current SOC 51 is an SOC[%] of the storage battery 101 at the time of the travel planning (current time). The current SOC 51 is an example of the first predetermined value based on a charging state of the storage battery 101. A traveling section 52 is each traveling section included in the scheduled traveling route from a current position to a destination.

A vehicle speed estimated value 53 is an estimated value of a vehicle speed (for example, an average vehicle speed) in each of the traveling sections 52. A third predetermined value 53a is the above-described third predetermined value for determining whether a traveling section is a low-speed section such as an urban area.

An output estimated value 54 is an estimated value of an output required for traveling in each of the traveling sections 52. A second predetermined value 54a is the above-described fourth predetermined value for determining whether a traveling section is a section in which particularly high output is required among the high-output sections.

A section type 55 is a type of each of the traveling sections 52 based on the vehicle speed estimated value 53 and the output estimated value 54. The section type 55 is any one of “low speed” section, “high speed/low output” section, and “high speed/high output” section. The “Low speed” section indicates a traveling section in which a vehicle speed estimated value 53 is equal to or less than a third predetermined value 53a. Since the “low speed” traveling section is excluded from the planning target section, the “low output” section and the “high output” section are not distinguished here.

The “high speed/low output” section indicates a traveling section in which a vehicle speed estimated value 53 exceeds a third predetermined value 53a and an output estimated value 54 is equal to or lower than a second predetermined value 54a. The “high speed/high output” section indicates a traveling section in which a vehicle speed estimated value 53 exceeds a third predetermined value 53a and an output estimated value 54 exceeds a second predetermined value 54a.

A travelling plan 56 (final value) is a travelling plan created by the processing shown in FIG. 4. The travelling plan 56 is obtained by assigning any one of the EV mode (EV), the assist traveling mode (AST), and the non-assist traveling mode (EG) to each of the traveling sections 52.

A required electric power amount estimated value 57 is an estimated value[kWh] of the amount of electric power required for traveling in each of the traveling sections 52 based on the traveling plan 56.

A required electric power amount total estimated value 58 is a value obtained by integrating the required electric power amount estimated values 57 in the traveling sections 52. According to the processing shown in FIG. 4, the management ECU 125 creates the travelling plan 56 so that the required electric power amount total estimated value 58 does not exceed the current SOC 51, that is, so that the SOC of the storage battery 101 is sufficient up to the destination.

FIG. 5 shows an example in which the current SOC 51 is sufficiently high. In the example of FIG. 5, two traveling sections among the traveling sections 52 are determined to be the “high speed/high output” section and the assist traveling mode (AST) is assigned to these two traveling sections, and at this time, the current SOC 51 exceeds the required electric power amount total estimated value 58, and the traveling plan 56 is created. Note that the EV mode (EV) as the initial value remains assigned to the other traveling sections.

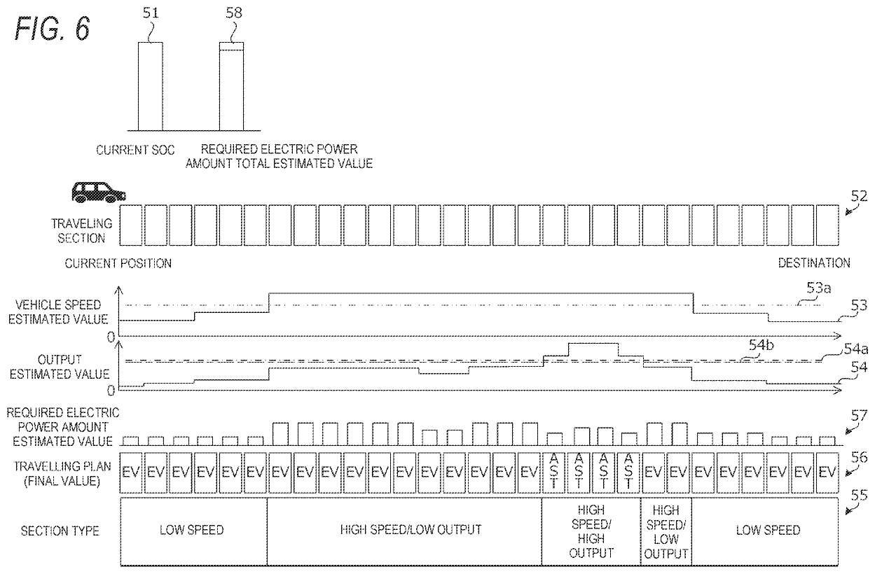

FIG. 6 shows an example in which a current SOC 51 is lower than that in the example of FIG. 5. In the example of FIG. 6, as a result of performing the assignment based on the second predetermined value 54a shown in FIG. 5, the current SOC 51 does not exceed the required electric power amount total estimated value 58, and the processing of reducing the second predetermined value 54a is performed. As a result, four traveling sections are determined to be the “high speed/high output” section and the assist traveling mode (AST) is assigned to the four traveling sections, and at this time, the current SOC 51 exceeds the required electric power amount total estimated value 58, and the travelling plan 56 is created.

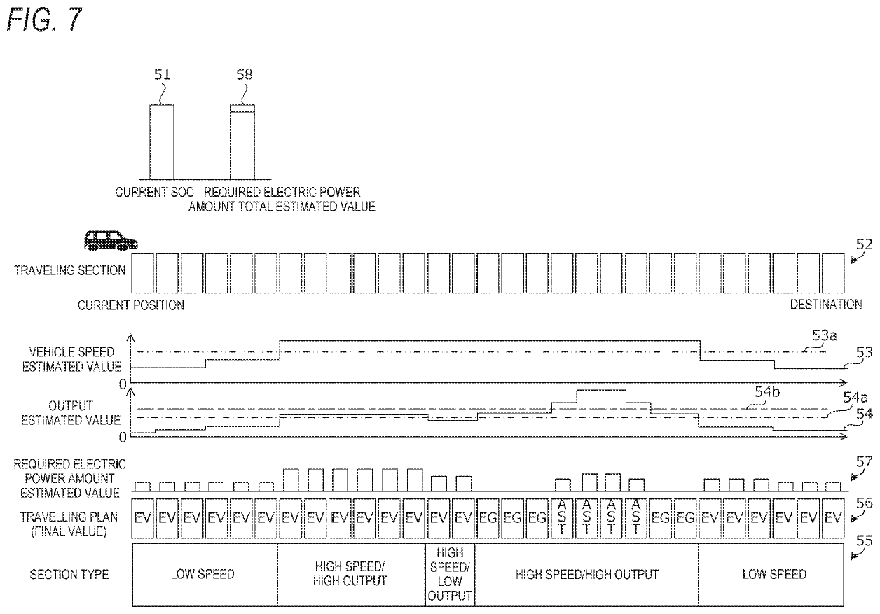

FIG. 7 shows an example in which a current SOC 51 is lower than that in the example of FIG. 6. In the example of FIG. 7, as a result of performing the assignment based on the second predetermined value 54a shown in FIG. 6, the current SOC 51 does not exceed the required electric power amount total estimated value 58, and the processing of further reducing the second predetermined value 54a is performed. As a result, 15 traveling sections are determined to be the “high speed/high output” section. The assist traveling mode (AST) or the non-assist traveling mode (EG) is assigned to nine traveling sections distant from a current position among these traveling sections in accordance with whether the output estimated value 54 exceeds the fourth predetermined value 54b, and at this time, the current SOC 51 exceeds the required electric power amount total estimated value 58, and the travelling plan 56 is created.

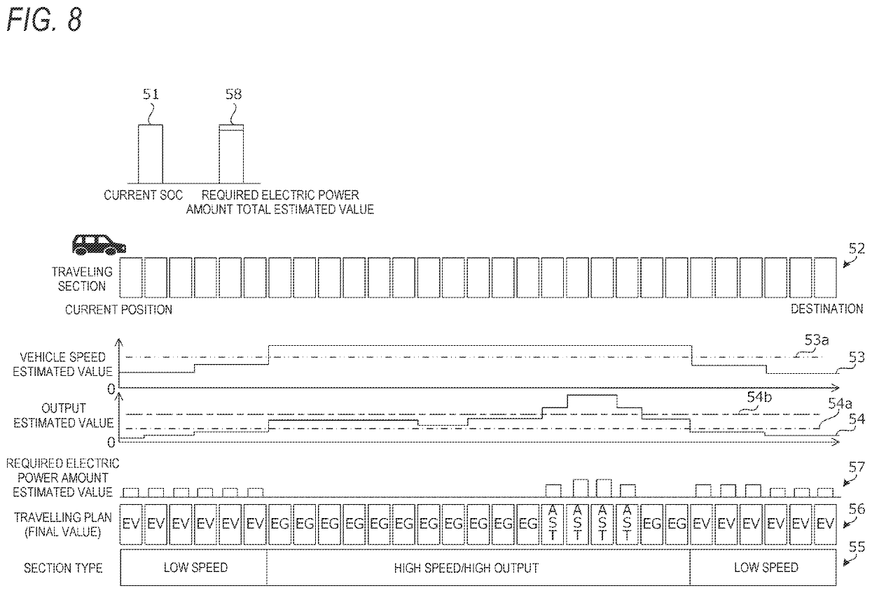

FIG. 8 shows an example in which a current SOC 51 is lower than that in the example of FIG. 7. In the example of FIG. 8, as a result of performing the assignment based on the second predetermined value 54a shown in FIG. 7, the current SOC 51 does not exceed the required electric power amount total estimated value 58, and the processing of further reducing the second predetermined value 54a is performed. As a result, 17 traveling sections are determined to be the “high speed/high output” section. The assist traveling mode (AST) or the non-assist traveling mode (EG) is assigned to all of the traveling sections in accordance with whether the output estimated value 54 exceeds the fourth predetermined value 54b, and at this time, the current SOC 51 exceeds the required electric power amount total estimated value 58, and the travelling plan 56 is created.

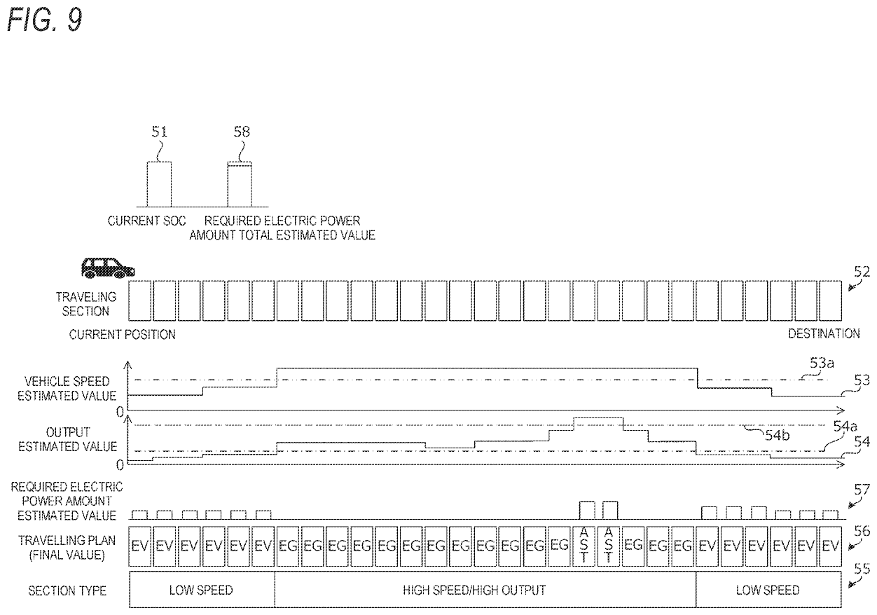

FIG. 9 shows an example in which a current SOC 51 is lower than that in the example of FIG. 8. In the example of FIG. 9, as a result of performing the assignment based on the second predetermined value 54a shown in FIG. 8, the current SOC 51 does not exceed the required electric power amount total estimated value 58, and the processing of increasing the fourth predetermined value 54b is performed. As a result, the non-assist traveling mode (EG) is assigned to the two traveling sections as “high speed/high output” sections to which the assist traveling mode (AST) has been assigned, and accordingly, the current SOC 51 exceeds the required electric power amount total estimated value 58, and the travelling plan 56 is created.

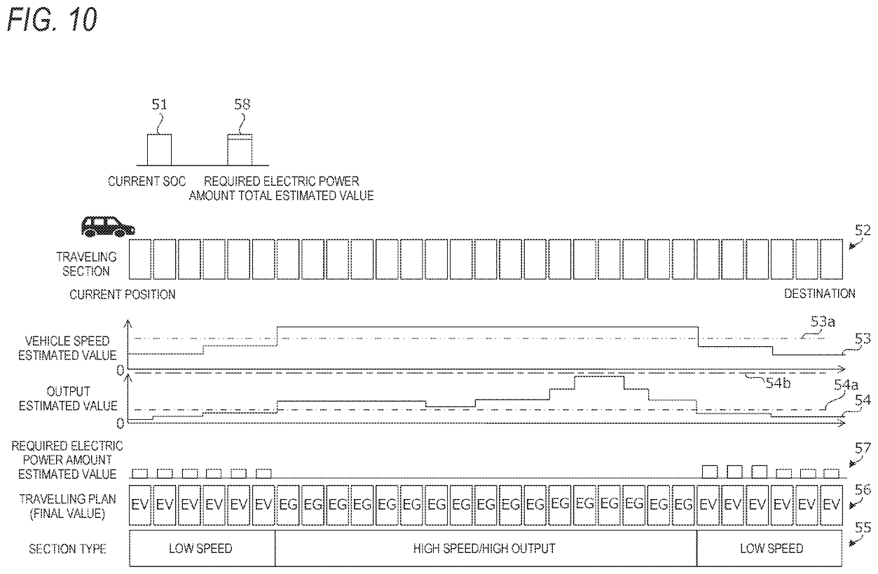

FIG. 10 shows an example in which a current SOC 51 is lower than that in the example of FIG. 9. In the example of FIG. 10, as a result of performing the assignment shown in FIG. 9, the current SOC 51 does not exceed the required electric power amount total estimated value 58, and the processing of further increasing the fourth predetermined value 54b is performed. As a result, the non-assist traveling mode (EG) is assigned to the two traveling sections as “high speed/high output” sections to which the assist traveling mode has been assigned, and accordingly, the current SOC 51 exceeds the required electric power amount total estimated value 58, and the traveling plan 56 is created.

As described above, according to the control device for an electrical vehicle of the present embodiment, when the electrical vehicle cannot complete the scheduled traveling route in the first travel mode, the second traveling mode is preferentially assigned to a traveling section, in which a required output is high, among the traveling sections of the scheduled traveling route, and thus, the internal combustion engine can be operated efficiently in the traveling section in which the required output is high. Therefore, it is possible to reduce the deterioration of fuel consumption.

The second traveling mode at which the usage amount of electric power of the storage battery is small is assigned preferentially to a traveling section farther from the electrical vehicle, so that the second traveling mode is easily assigned to adjacent traveling sections collectively, and hunting that the first traveling mode and the second traveling mode are frequently switched can be prevented. In addition, the electric power of the storage battery is positively used from an early stage during the traveling according to the scheduled traveling route, and it is possible to prevent the electric power of the storage battery from being excessive when the electrical vehicle arrives at the destination. Therefore, the external electric power can be efficiently used in the electrical vehicle including the storage battery that can be charged with the external electric power.

As described above, according to the control device for the electrical vehicle of the present embodiment, it is possible to improve the energy efficiency of traveling while preventing hunting of control.

Although the embodiment of the present invention has been described above, the present invention is not limited to the above embodiment, and can be appropriately modified, improved, or the like.

For example, the configuration in which the control device of the present invention is applied to the management ECU 125 has been described, and at least a part of the control device of the present invention may be applied to a device other than the management ECU 125. Here, the device other than the management ECU 125 may be a device (for example, the navigation system 131) of the electrical vehicle 1, or may be a device (for example, the server 133) outside the electrical vehicle 1.

The EV mode has been described as an example of the first traveling mode of the present invention, but the first traveling mode is not limited to the EV mode as long as the usage amount of electric power of the storage battery 101 is larger than that in the second traveling mode. For example, the first traveling mode may be a mode in the series mode, in which the electric power from the storage battery 101 is used as the assist electric power, or may be a mode in the engine direct connection mode, in which the driving force of the electric motor 107 driven by the supply of electric power from the storage battery 101 is used. In this case, the second traveling mode may be a mode in the series mode, in which the electric power from the storage battery 101 is not used as the assist electric power, or may be a mode in the engine direct connection mode, in which the driving force of the electric motor 107 driven by the supply of electric power from the storage battery 101 is not used. In addition, even when the electrical vehicle is traveling in a section to which the EV mode is assigned, the EV mode can be switched to another traveling mode as appropriate when the current SOC of the storage battery is equal to or less than a predetermined value or when a driver performs an operation of switching the traveling mode.

An example in which the navigation system 131 acquires information on roads such as a road type and a legal speed limit from the server 133 has been described in the above embodiment, and these pieces of information may be stored in the navigation system 131 in advance. In this case, for example, the navigation system 131 may read required information in accordance with a destination input by a user from information stored in the navigation system 131 in advance. That is, in this case, the server 133 or the communication function of the navigation system 131 for communicating with the server 133 may not be provided.

In the present specification, at least the following matters are described. Although the corresponding constituent elements or the like in the above embodiment are shown in parentheses, the present invention is not limited thereto.

(1) A control device (management ECU 125) for an electrical vehicle (electrical vehicle 1) that includes an internal combustion engine (internal combustion engine 109), a storage battery (storage battery 101), and an electric motor (electric motor 107) driven by the supply of electric power from the storage battery, and can travel in a plurality of traveling modes including a first traveling mode (EV mode) and a second traveling mode (assist traveling mode, non-assist traveling mode) in which a usage amount of electric power of the storage battery is smaller than that in the first traveling mode, the control device (management ECU 125) comprising:

a travelling planning unit configured to create a travelling plan (travelling plan 56) in which any one of the plurality of travelling modes is assigned to each of traveling sections (traveling section 52) of a scheduled traveling route from a current position of the electrical vehicle to a destination; and

a control unit configured to control the travelling modes of the electrical vehicle based on the travelling plan created by the travelling planning unit;

wherein, when a total estimated value of an amount of electric power required for traveling (required electric power amount total estimated value 58) in each of the traveling sections in the first traveling mode exceeds a first predetermined value (current SOC 51) based on a charging state of the storage battery at the time of creating the traveling plan, the travelling planning unit extracts a section in which an estimated value of an output required for traveling (output estimated value 54) exceeds a second predetermined value (second predetermined value 54a) from the traveling sections as a planning target section, and creates the traveling plan in which the second traveling mode is assigned preferentially to a section farther from the electrical vehicle among the planning target sections.

According to (1), when the electrical vehicle cannot complete the scheduled traveling route in the first travel mode, the second traveling mode is preferentially assigned to a traveling section, in which a required output is high, among the traveling sections of the scheduled traveling route, and thus, the internal combustion engine can be operated efficiently in the traveling section in which the required output is high. Therefore, it is possible to reduce the deterioration of fuel consumption.

In addition, according to (1), the second traveling mode at which the usage amount of electric power of the storage battery is small is assigned preferentially to a traveling section farther from the electrical vehicle, so that the second traveling mode is easily assigned to adjacent traveling sections collectively, and hunting that the first traveling mode and the second traveling mode are frequently switched can be prevented. In addition, the electric power of the storage battery is positively used from an early stage during the traveling according to the scheduled traveling route, and it is possible to prevent the electric power of the storage battery from being excessive when the electrical vehicle arrives at the destination. Therefore, the external electric power can be efficiently used in the electrical vehicle including the storage battery that can be charged with the external electric power.

Therefore, according to (1), it is possible to improve the energy efficiency of traveling while preventing hunting of control.

(2) The control device according to (1), in which

wherein the first traveling mode is a traveling mode in which the electrical vehicle travels using electric power of the storage battery in preference to power of the internal combustion engine, and

the second traveling mode is a traveling mode in which the electrical vehicle travels using the power of the internal combustion engine in preference to the electric power of the storage battery.

According to (2), the second traveling mode in which the electrical vehicle travels by preferentially using the power of the internal combustion engine is preferentially assigned to the traveling section in which the required output is high, and the internal combustion engine can be efficiently operated.

(3) The control device according to (1) or (2), wherein the travelling planning unit is configured to extract, as the planning target section, a section in which the estimated value of the output required for the travelling exceeds the second predetermined value and an estimated value of a vehicle speed (vehicle speed estimated value 53) exceeds a third predetermined value (third predetermined value 53a) from the traveling sections.

According to (3), the section which is highly likely to be an urban area or the like and in which the estimated value of the vehicle speed is low is not set as the planning target section of the second traveling mode even if the section is a travelling section in which the required output is high, and thus the deterioration of the fuel efficiency can be prevented.

(4) The control device according to any one of (1) to (3), wherein the second traveling mode includes a first mode (non-assist travelling mode) in which an amount of electricity stored in the storage battery is maintained within a predetermined range, and a second mode (assist travelling mode) in which traveling using power of the internal combustion engine is assisted by driving of the electric motor with electric power of the storage battery, and the travelling planning unit is configured to create the travelling plan in which the first mode is assigned to a section, among the planning target sections, in which the estimated value of the output required for the travelling is equal to or less than a fourth predetermined value (fourth predetermined value 54b), and the second mode is assigned to a section, among the planning target sections, in which the estimated value of the output required for the travelling exceeds the fourth predetermined value.

According to (4), the second mode in which the travelling using the power of the internal combustion engine is assisted by the driving of the electric motor with the electric power of the storage battery is assigned to a section in which the required output is particularly high among the traveling sections in which the required output is high, so that the internal combustion engine can be efficiently operated and the deterioration of the fuel efficiency can be prevented.

(5) The control device according to any one of (1) to (4), wherein the travelling planning unit is configured to perform re-extraction of the planning target section and re-creating of a travelling plan by reducing the second predetermined value when a total estimated value of an amount of electric power required for travelling in each of the traveling sections in the travelling plan created by assigning the second traveling mode to each of the planning target section exceeds the first predetermined value, and

the control unit is configured to control the traveling mode of the electrical vehicle based on the traveling plan re-created by the traveling planning unit.

According to (5), when the electric power of the storage battery is insufficient even when the second traveling mode in which the usage amount of the electric power of the storage battery is small is assigned to each of the planning target sections, the number of planning target sections to which the second traveling mode is assigned is increased to re-create a travelling plan, and thus, it is possible to create a travelling plan by which the scheduled traveling route can be completed.

(6) The control device according to any one of (1) to (5),

wherein the travelling planning unit is configured to re-create a travelling plan regularly or irregularly during travelling of the electrical vehicle based on the travelling plan, and

the control unit is configured to control the traveling mode of the electrical vehicle based on the traveling plan re-created by the traveling planning unit.

According to (6), by updating the travelling plan even during the travelling of the electrical vehicle, it is possible to prevent a situation in which electric power of the storage battery becomes excessive at the time of arriving at the destination due to an error in the estimated value of the required output or the like.

(7) A control method of an electrical vehicle that includes an internal combustion engine, a storage battery, and an electric motor driven by the supply of electric power from the storage battery, and travels in a plurality of traveling modes including a first traveling mode and a second traveling mode in which a usage amount of electric power of the storage battery is smaller than that in the first traveling mode, the control method comprising:

a travelling planning step of creating a travelling plan in which any one of the plurality of travelling modes is assigned to each of traveling sections of a scheduled traveling route from a current position of the electrical vehicle to a destination; and

a control step of controlling the travelling modes of the electrical vehicle based on the travelling plan created by the travelling planning step,

wherein when a total estimated value of an amount of electric power required for traveling in each of the traveling sections in the first traveling mode exceeds a first predetermined value based on a charging state of the storage battery at the time of creating the traveling plan, a section in which an estimated value of an output required for traveling exceeds a second predetermined value is extracted from the traveling sections as a planning target section, and the traveling plan in which the second traveling mode is assigned preferentially to a section farther from the electrical vehicle among the planning target sections is assigned in the travelling planning step.

According to (7), similarly to (1), it is possible to improve the energy efficiency of traveling while preventing hunting of control.

(8) An electrical vehicle, which includes an internal combustion engine, a storage battery, and an electric motor driven by the supply of electric power from the storage battery, and travels in a plurality of traveling modes including a first traveling mode and a second traveling mode in which a usage amount of electric power of the storage battery is smaller than that in the first traveling mode, the electrical vehicle comprising:

a travelling planning unit configured to create a travelling plan in which any one of the plurality of travelling modes is assigned to each of traveling sections of a scheduled traveling route from a current position of the electrical vehicle to a destination; and

a control unit configured to control the travelling modes of the electrical vehicle based on the travelling plan created by the travelling planning unit;

wherein, when a total estimated value of an amount of electric power required for traveling in each of the traveling sections in the first traveling mode exceeds a first predetermined value based on a charging state of the storage battery at the time of creating the traveling plan, the travelling planning unit extracts a section in which an estimated value of an output required for traveling exceeds a second predetermined value from the traveling sections as a planning target section, and creates the traveling plan in which the second traveling mode is assigned preferentially to a section farther from the electrical vehicle among the planning target sections.

According to (8), similarly to (1), it is possible to improve the energy efficiency of traveling while preventing hunting of control.

1. A control device for an electrical vehicle that includes an internal combustion engine, a storage battery, and an electric motor driven by the supply of electric power from the storage battery and travels in a plurality of traveling modes including a first traveling mode and a second traveling mode in which a usage amount of electric power of the storage battery is smaller than that in the first traveling mode, the control device comprising:
a travelling planning unit configured to create a travelling plan in which any one of the plurality of travelling modes is assigned to each of traveling sections of a scheduled traveling route from a current position of the electrical vehicle to a destination; and
a control unit configured to control the travelling modes of the electrical vehicle based on the travelling plan created by the travelling planning unit;
wherein, when a total estimated value of an amount of electric power required for traveling in each of the traveling sections in the first traveling mode exceeds a first predetermined value based on a charging state of the storage battery at the time of creating the traveling plan, the travelling planning unit extracts a section in which an estimated value of an output required for traveling exceeds a second predetermined value from the traveling sections as a planning target section, and creates the traveling plan in which the second traveling mode is assigned preferentially to a section farther from the electrical vehicle among the planning target sections.

2. The control device according to claim 1,
wherein the first traveling mode is a traveling mode in which the electrical vehicle travels using electric power of the storage battery in preference to power of the internal combustion engine, and
the second traveling mode is a traveling mode in which the electrical vehicle travels using the power of the internal combustion engine in preference to the electric power of the storage battery.

3. The control device according to claim 1,
wherein the travelling planning unit is configured to extract, as the planning target section, a section in which the estimated value of the output required for the travelling exceeds the second predetermined value and an estimated value of a vehicle speed exceeds a third predetermined value from the traveling sections.

4. The control device according to claim 1,
wherein the second traveling mode includes a first mode in which an amount of electricity stored in the storage battery is maintained within a predetermined range, and a second mode in which traveling using power of the internal combustion engine is assisted by driving of the electric motor with electric power of the storage battery, and
the travelling planning unit is configured to create the travelling plan in which the first mode is assigned to a section, among the planning target sections, in which the estimated value of the output required for the travelling is equal to or less than a fourth predetermined value, and the second mode is assigned to a section, among the planning target sections, in which the estimated value of the output required for the travelling exceeds the fourth predetermined value.

5. The control device according to claim 1,
wherein the travelling planning unit is configured to perform re-extraction of the planning target section and re-creating of a travelling plan by reducing the second predetermined value when a total estimated value of an amount of electric power required for travelling in each of the traveling sections in the travelling plan created by assigning the second traveling mode to each of the planning target section exceeds the first predetermined value, and
the control unit is configured to control the traveling mode of the electrical vehicle based on the traveling plan re-created by the traveling planning unit.

6. The control device according to claim 1,
wherein the travelling planning unit is configured to re-create a travelling plan regularly or irregularly during travelling of the electrical vehicle based on the travelling plan, and
the control unit is configured to control the traveling mode of the electrical vehicle based on the traveling plan re-created by the traveling planning unit.

7. A control method of an electrical vehicle that includes an internal combustion engine, a storage battery, and an electric motor driven by the supply of electric power from the storage battery, and travels in a plurality of traveling modes including a first traveling mode and a second traveling mode in which a usage amount of electric power of the storage battery is smaller than that in the first traveling mode, the control method comprising:
a travelling planning step of creating a travelling plan in which any one of the plurality of travelling modes is assigned to each of traveling sections of a scheduled traveling route from a current position of the electrical vehicle to a destination; and
a control step of controlling the travelling modes of the electrical vehicle based on the travelling plan created by the travelling planning step,
wherein when a total estimated value of an amount of electric power required for traveling in each of the traveling sections in the first traveling mode exceeds a first predetermined value based on a charging state of the storage battery at the time of creating the traveling plan, a section in which an estimated value of an output required for traveling exceeds a second predetermined value is extracted from the traveling sections as a planning target section, and the traveling plan in which the second traveling mode is assigned preferentially to a section farther from the electrical vehicle among the planning target sections is assigned in the travelling planning step.

8. An electrical vehicle, which includes an internal combustion engine, a storage battery, and an electric motor driven by the supply of electric power from the storage battery, and travels in a plurality of traveling modes including a first traveling mode and a second traveling mode in which a usage amount of electric power of the storage battery is smaller than that in the first traveling mode, the electrical vehicle comprising:
a travelling planning unit configured to create a travelling plan in which any one of the plurality of travelling modes is assigned to each of traveling sections of a scheduled traveling route from a current position of the electrical vehicle to a destination; and
a control unit configured to control the travelling modes of the electrical vehicle based on the travelling plan created by the travelling planning unit;
wherein, when a total estimated value of an amount of electric power required for traveling in each of the traveling sections in the first traveling mode exceeds a first predetermined value based on a charging state of the storage battery at the time of creating the traveling plan, the travelling planning unit extracts a section in which an estimated value of an output required for traveling exceeds a second predetermined value from the traveling sections as a planning target section, and creates the traveling plan in which the second traveling mode is assigned preferentially to a section farther from the electrical vehicle among the planning target sections.
